(19) United States
(12) Patent Application Publication
(10) Pub. No.: US 2007/0285476 A1
(43) Pub. Date: Dec. 13, 2007

(54) Ink jet cartridge refilling machine with protected needles

(76) Inventors: E. Mariano Freire, Kennet Square, PA (US); James Bryan Hudson, Wilmington, DE (US); Sergio Tonini, Franklin, TN (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/732,175

(22) Filed: Apr. 2, 2007

Related U.S. Application Data
(60) Provisional application No. 60/794,668, filed on Apr. 24, 2006.

(51) Int. Cl. B41J 2/175

(52) U.S. Cl. 347/85

(57) ABSTRACT

A method and apparatus is provided for refilling an ink reservoir associated with an ink jet printer cartridge containing foam material in the ink chamber of the cartridge. A fill fixture is provided with one or more needles to deliver ink to the cartridge wherein the needle(s) are protected by a needle guard which prevents the user from needle stick injuries and also prevents the needles from being damaged.

### CROSS-REFERENCE TO RELATED APPLICATION

This application claims priority under 35 U.S.C. §119 from U.S. Provisional Application Ser. No. 60/794,668, filed Apr. 24, 2006 which is hereby incorporated by reference in its entirety.

### FIELD OF THE INVENTION

The present invention relates to ink jet cartridges. More specifically, the invention relates to an improved method and device used to refill ink jet cartridges with inks.

### BACKGROUND OF THE INVENTION

Ink jet printing is a non-impact printing process in which droplets of ink are deposited on print media, such as paper, to form the desired image. The droplets are ejected from a printhead in response to electrical signals generated by a microprocessor.

Many of these ink jet printers contain ink cartridges. The ink cartridges can simply be ink tanks containing a supply of ink or can be integrated printhead cartridges which incorporate both an ink tank and printhead. To prevent ink from leaking out of the cartridge during handling and non-use, the ink is usually stored under negative pressure. This is sometimes achieved by having the ink chamber house either a porous material, such as foam or sponge, or a collapsible bladder attached to a system of plates and springs to contain the ink supply.

An ink cartridge may have only one ink chamber and contain only a single color ink, such as black ink (K) for a monochrome printer. Typical color printers use one cartridge that holds only black ink (K) and a second cartridge that has three separate ink chambers that contain three different colors of ink that can be blended to produce any color in the spectrum. The three colors most often used are cyan (C), magenta (M), and yellow (Y). Individual colors may also be provided via individual cartridges.

As the printing process consumes the ink in a printer cartridge and the cartridge is depleted (including the case where only one of the inks from a tricolor cartridge is depleted), the cartridge must be replaced or refilled.

Nowadays, most users simply discard the old cartridge and buy an entirely new printer cartridge when the ink cartridge in use is emptied, which is a very expensive proposition that is difficult to bear. However, particularly with regard to integrated head ink cartridges, the current printhead technology has advanced to the point where the useful life and reliability of the structural components of the printhead, such as the resistive heater elements that enable vaporization and ejection of ink in thermal ink jet cartridges, extend far beyond the usage life of the self-contained ink supply. It is seen that discarding an ink cartridge simply because its ink charge has been expended is wasteful and environmentally unfriendly.

Therefore, some users have attempted to refill cartridges with a new supply of ink using presently available do-it-yourself cartridge refilling systems, but these systems are often cumbersome for the user and very messy from the standpoint of spills. The cartridges' printing nozzles may also be damaged during refilling.

Technologies have recently developed that have enabled the construction of refill stations that can be operated as kiosks in retail outlets where customers can bring their empty ink cartridges for refilling. Such refilling stations are disclosed in, for example, U.S. Pat. Application Pub. No. 2006/0017789, U.S. Pat. Application Pub. No. 2005/003477, U.S. Pat. No. 6,729,360, and commonly-owned U.S. patent application Ser. No. 11/236.989 (filed Sep. 28, 2005), the disclosure of which is incorporated herein by reference for all purposes as if fully set forth. These stations allow the consumer more affordable options for filling the cartridge, are environmentally favorable since old cartridges can be recycled, reduce the risk of damage to the cartridge, ensure that the cartridge is filled with the proper ink type and quantity, and also perform a cartridge diagnostic to ensure the cartridge is operating property and does not pose a hazard to the printing device.

The most common approach to refill foam-based cartridges is through either an already existing vent hole or a new hole formed in the cartridge, using an ink-filled syringe or other similar tubular device connected to a refill ink supply. Such method therefore typically involves the use of hollow needles that are inserted in the cartridge to deliver the ink.

Methods that involve needles are particularly useful for refilling cartridges with foam or other porous material because the needles can conveniently place the ink inside the foam. Once the ink is placed in the foam so that the foam is at least partially saturated, the capillary force delivered by the pores in the material provides the negative pressure to the ink line that prevents the ink from leaking out of the nozzles.

However, the needles used to refill ink jet cartridges tend to be long and, often, more than one needle is used, especially if the cartridge to be refilled has more than one ink type or color. It is therefore the case that the handling of these needles pose a risk to the user who can accidentally harm him or herself quite easily. Because of their length these needles are also fragile and can break or bend easily if not handled carefully.

Thus, there is still a need for safer methods and devices that can be used to fill empty ink jet cartridges with replacement ink.

### SUMMARY OF THE INVENTION

The present invention solves the safety problem posed by the needles used in ink jet cartridge refill kits, refill stations, and other similar devices. It also prevents damage to the needles during the normal operation of the refill devices.

The invention comprises protecting the needle or needles for refilling ink jet cartridges with a structure.

More particularly, the invention resides in a fill fixture suitable for refilling an ink jet cartridge, having a base and affixed to the base, at least one hollow needle to deliver ink to said cartridge, where the at least one needle is prevented from accidentally harming the user or breakage by a partially to totally surrounding protecting structure extending from the base along the entire length of the longest needle and spaced apart from the needle to define a space to admit the empty ink jet cartridge being refilled.

### BRIEF DESCRIPTION OF THE DRAWINGS

The accompanying drawings illustrate preferred embodiments of the present invention and are a part of the specification. Together with the following description, the drawings demonstrate and explain the principles of the present invention. The illustrated embodiments are examples of the present invention and do not limit the scope of the invention. In the drawings:

FIG. 1 is a perspective view of an ink jet cartridge refilling station employing a cartridge refill device with protected needles according to an embodiment of the present invention.

FIG. 2 shows a vacuum filling chamber and fill fixture with protected needles.

FIG. 3 is an illustration of a first embodiment of an ink cartridge refill device with protected needles according to the present invention.

FIG. 4 is an illustration of a second embodiment of an ink cartridge refill device with protected needles according to the present invention.

FIG. 5 is an illustration of a third embodiment of an ink cartridge refill device with protected needles according to the present invention.

FIG. 6 is an illustration of fourth embodiment of an ink cartridge refill device with protected needles according to the present invention.

### DETAILED DESCRIPTION OF THE PREFERRED EMBODIMENTS

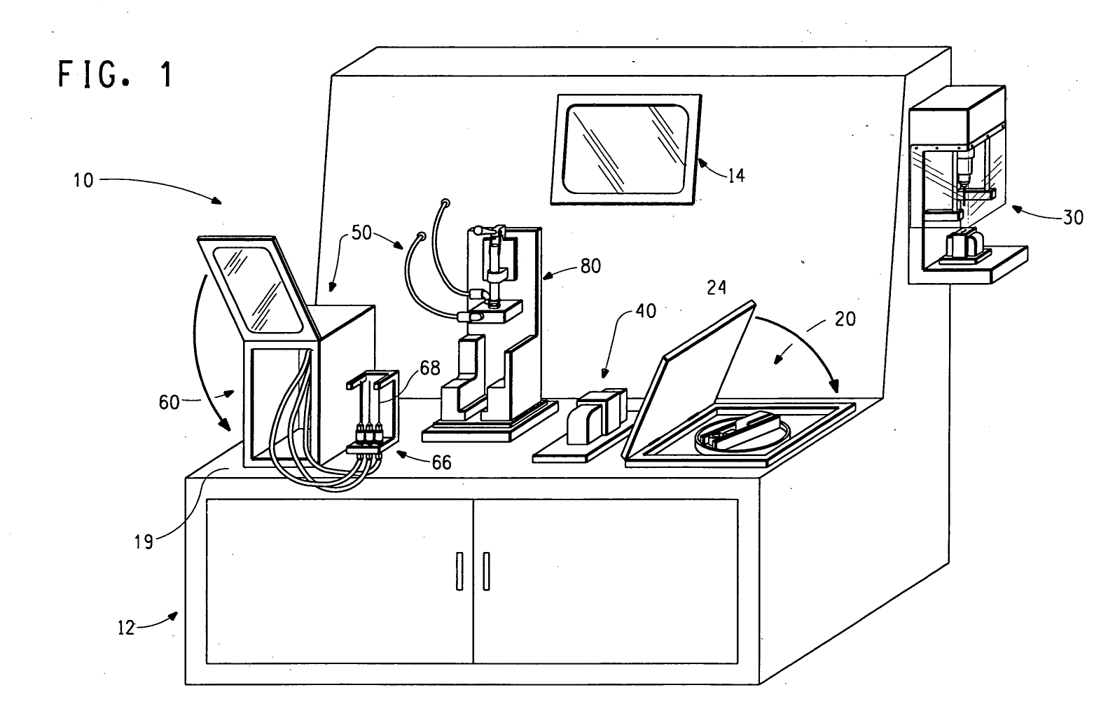

Referring to the drawings, in which like numerals indicate like elements throughout, there is shown in FIG. 1 a drawing of an ink cartridge refilling station 10 in which the fill fixture according to the invention can be used.

The ink refilling station 10 as shown in FIG. 1 provides a system that allows a user, preferably a trained retail associate, to add ink to a printer cartridge. The refilling station 10 is preferably operated as a kiosk in a location that is publicly available, such as in a retail store for office supplies. The cartridge refilling station is suitable for refilling and testing a variety of used ink jet cartridges (such as those by different printer manufacturers) quickly, easily and affordably.

The cartridge refilling machine 10 comprises a cabinet 12 that houses a computer (not depicted), a touch screen display 14 for the computer, a centrifuge station 20 for removing residual ink from the cartridge, a drill station 30 for drilling new ink fill holes in the cartridge, a cleaning station 40 for cleaning the cartridge before refilling, an ink supply reservoir (not depicted) that contains inks for various different cartridges, and a filling station 50 containing one or more fill fixtures (as discussed below) in communication with the ink supply reservoir for delivering ink to the empty cartridge.

In general, the computer controls the operation of the refilling machine via software loaded onto the computer, and in conjunction with input received from the operator via the touch screen display; the cleaning station is for cleaning the integrated printhead of the cartridge; the centrifuge station is for removing at least a substantial portion of the residual ink from the ink tank of the cartridge; the drill station is for drilling one or more access holes to the ink tank of the cartridge (where required); and the filling station is for filling replacement ink into the ink tank of the cartridge.

The machine 10 further includes a circuit test station (not depicted) for testing the cartridge electronics prior and/or subsequent to refilling, and a print test station (not depicted) for testing the print functionality of the cartridge subsequent to refilling. The circuit and print test stations may be separate from (not an integrated part of) machine 10, but are preferably part of an integrated assembly and are housed in cabinet 12.

Cabinet 12 provides a suitable housing for the touch screen display 14, and further houses the centrifuge station 20, the drill station 30, the cleaning station 40 and the filling station 50, as well as all associated valves, pumps, tubing, and computer and electronic process control systems in connection therewith (not depicted but as described in further detail below). The cabinet 12 may also contain any other items that the operator desires to store, or that is convenient for the operation of machine 10, such as counterweights for use with centrifuge station 20, a compressor for use with cleaning station 40 and the filling station, and containers of replacement ink.

The ink jet cartridge refilling machine as shown is capable of processing, refilling and testing a used ink jet ink cartridge of various types including the type containing (a) a stand alone ink tank with residual ink and (b) an integrated printhead. Depending on the type of cartridge being refilled, as noted above, different fill fixtures may be used.

The present invention will now be discussed generally in the context of refilling foam-based cartridges, particularly integrated head thermal ink jet cartridges. One skilled in the art would understand that the process of the present invention also is useful for refilling any foam-based cartridge, including integrated head, individual tanks, piezo, and thermal cartridges.

In the preferred embodiment as depicted in FIG. 1, the machine filling station includes at least one vacuum filling device 60 and preferably also includes a pressure filling device 80. The presence of both devices 60 and 80 provides the refilling machine 10 with the capability to process the two most common types of cartridges—those with a sponge or foam in the ink tank (using vacuum filling device 60) to which this invention pertains, and those with a bladder in the ink tank (using pressure filling device 80).

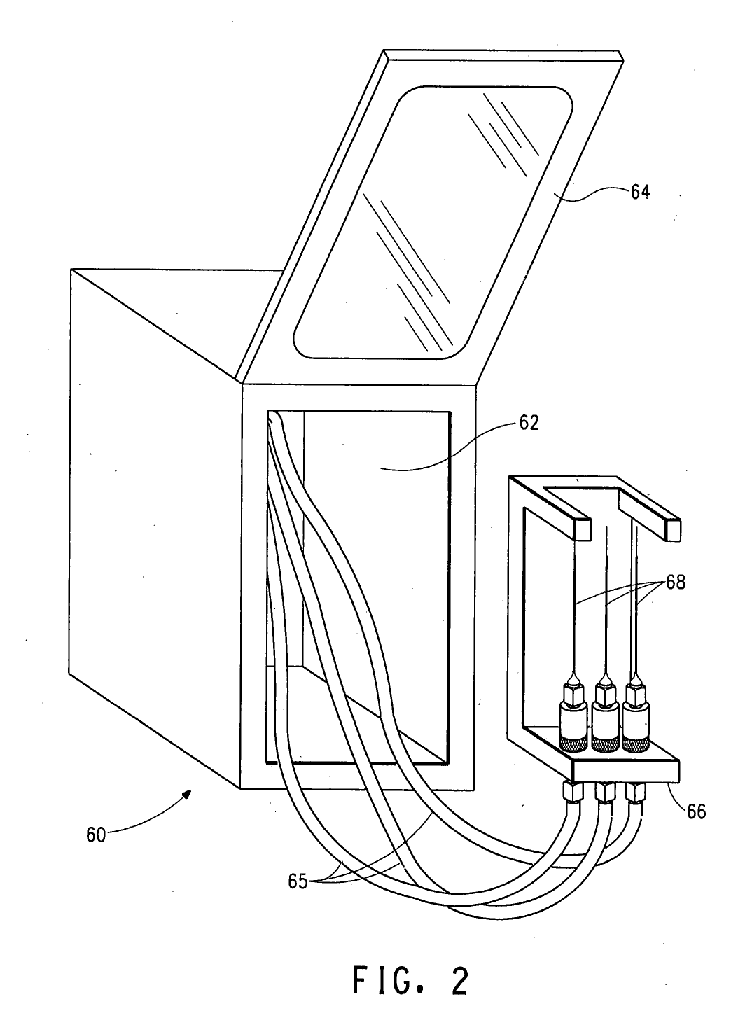

With respect to the cartridges that contain a sponge or foam in the ink reservoir, a fill fixture 66 with needles 68 is typically employed. As indicated above, the vacuum filling device 60 is designed for use with cartridges containing a sponge or other porous material in the ink tank and is depicted in more detail in FIG. 2.

Vacuum filling device 60 contains a chamber 62 including a hinged cover 64 which, when closed, allows the operator to utilize chamber 62 for negative air pressure cartridge filling. During filling, ink is metered from storage containers (not depicted) housed in cabinet 12 to the cartridge via flexible fill lines 65 and a fill fixture. A variety of fill fixtures can be utilized, such as fixture 66 in FIG. 2, each including hollow needles 68 of specific diameter, length and position designed allow the delivery of ink to specific cartridge types. For example, a simple black ink cartridge like the HP27 (Hewlett Packard Company) may need one needle, while a tri-color cartridge will need several needles, at least one for each color to be added to the cartridge.

The individual fill fixtures 66 are designed such that, when the needles 68 are inserted into the correspondingly matched cartridge holes (not depicted), the filling occurs in the ink tank of the cartridge as close to the integrated printhead as possible and also at a position that allows the ink to adequately impregnate or saturate the foam material. The negative air pressure (vacuum) in chamber 62 potentially helps draw the replacement ink to the integrated printhead, thereby removing any air or other potential blockage between the ink supply and the integrated printhead.

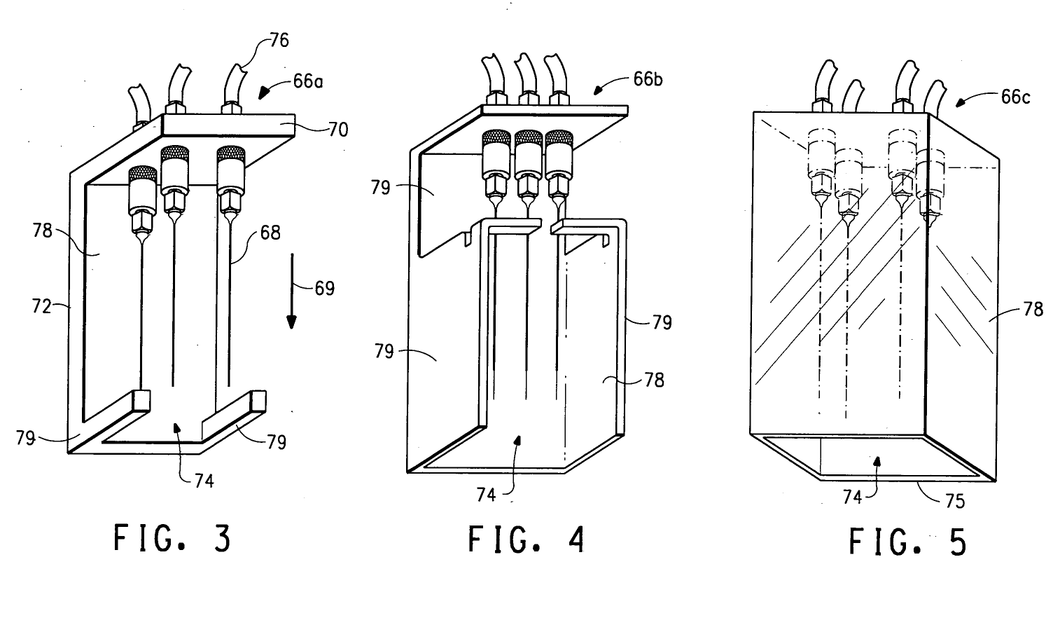

Referring now to FIG. 3, according to a first embodiment of the present invention an improved fill fixture 66a (“a” designating the first embodiment) is shown where the needles are protected from damage and from causing injury to the user. The invention thus solves the safety problem posed by the needles used in ink jet cartridge refill kits, refill stations, and other similar devices. It also prevents damage to the needles during the normal operation of the refill devices.

As shown in FIG. 3, the needles are enclosed within a protective structure (also referred to herein as a protective sheath or guard) generally surrounding at least a portion of the exposed needle(s) and protecting the needle or needles that are used for refilling ink jet cartridges from damage and causing injury (such as needle stick injuries) to the retail associate.

The fill fixture 66 includes a base 70 and one or more hollow needles 68 rigidly affixed to and extending from the base and which are used to deliver ink to said cartridge, where the needle(s) are prevented from accidentally harming the user or breakage by a partially to totally surrounding rigid structure or protective sheath or guard 72.

The needle guard 72 as shown preferably extends from the base along the entire length of the longest needle and surrounds at least a portion of the needle(s). The needle guard 72 is also spaced apart from the needles a sufficient distance to define a hollow interior space or cross section 74 that is of sufficient size and shape to admit the empty ink cartridge therein and allow insertion of the needle(s) into the access hole(s) formed in the cartridge. It is generally preferred that the interior spaced is sized and shaped to only allow the cartridge to be inserted in one direction so that ink is supplied to the proper ink chamber(s).

Also as shown in FIG. 3, each needle 68 also preferably contains an inlet port 76 that is in flow communication with the ink supply reservoir, the port being configured to receive replacement ink from the cartridge refilling station.

The partially to totally surrounding rigid structure 72 may also extend beyond the length of the longest needle. The fixture 66 may contain one or more needles 68 depending on the amount and size of ink chambers needed to be refilled. At least one needle is typically used for single color (such as black) cartridges (sometimes two or three to allow more uniform ink fillage) and at least three needles of the same or differing lengths are typically used to fill tri-color cartridges.

When the fill fixture of FIG. 3 is used to fill tri-color cartridges, the needles 68 affixed to the fill fixture 66a are preferably spaced asymmetrically apart to match corresponding asymmetrical fill holes drilled in the cartridges and prevent the wrong color ink from filling a cartridge chamber.

The needle guard 72 places a fixed barrier between the hands of the needle user and the point of the needle. It thus permits the hands of the user to remain behind the needle as it is covered.

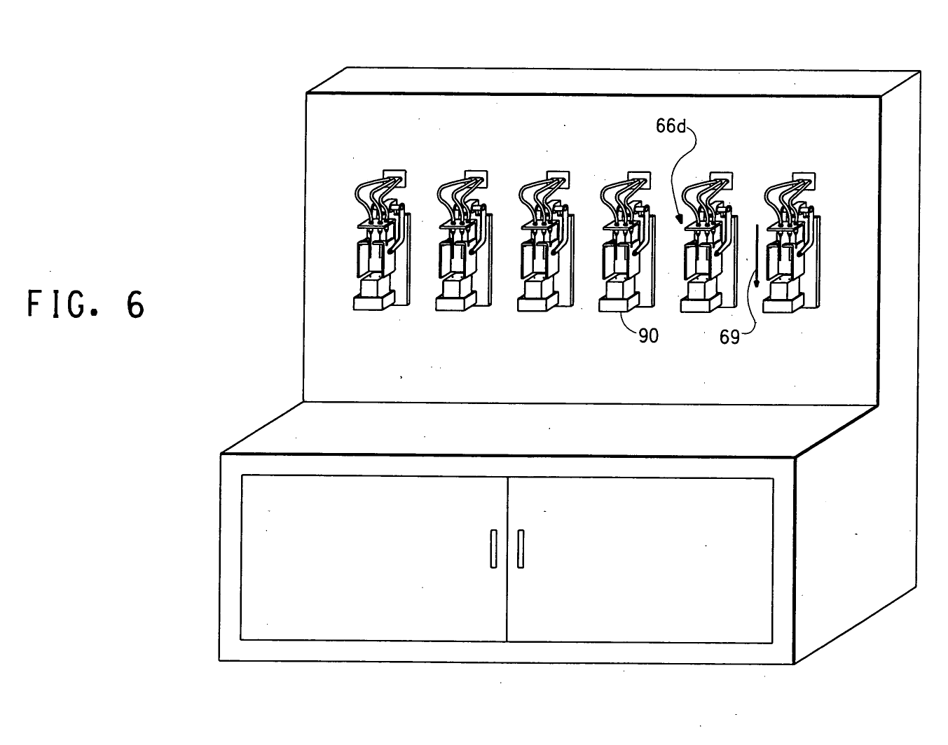

As best shown in FIGS. 3-5 (FIG. 4 and FIG. 5. being a second and a third embodiment, respectively), the needle guard 72 of the present invention may include, for all embodiments, a generally elongate rectangular or cylindrically-shaped housing 78 formed of a relatively rigid material so as to be generally impermeable to penetration by the needle or user's hands. Any common well-known metal or polymeric material exhibiting these characteristics may be used, the preferred embodiment of the present invention being formed of sheet metal.

The housing 78 of the guard 72 has formed therein an elongate generally rectangular (as shown) or cylindrical or circular chamber 74 (also referred to previously herein as an interior cross section or space 74). The chamber 74 is formed with at least a proximal end 75 opening through which the ink cartridge body can be inserted. In the alternative, the guard 72 might have another shape, so long as its interior cross section is adequate to admit the empty cartridge body being refilled.

As discussed, depending on the type of cartridge being filled, there is one or a plurality of needles configured in such a way to engage the access holes in flow communication and effectively fill the entire empty space of the ink reservoir and adequately impregnate the porous material with new ink.

As shown in FIG. 3, in the first embodiment of the invention the needle or needles are mounted on a base of a fixture with rectangular cross section and the protecting structure 72 is made of a rigid side wall 78 that covers one side of the rectangular cross section and two feet 79 on the plane opposite to the base to provide stability when the fixture stands on a horizontal surface.

In the second embodiment shown in FIG. 4, the fixture 66b (“b” designating the second embodiment) can also include where the needle or needles are mounted on a base with rectangular cross section and the protecting structure is made of a rigid material or side walls 79 that surrounds three sides of the base.

In a third embodiment, as shown in FIG. 5, the needle or needles are mounted on a base of a fixture 66c (“c” designating the second embodiment) with rectangular cross section and the protecting structure or side walls 79 surrounds the needles on all four sides.

Other embodiments are possible. In fourth embodiment (not depicted) the fixture could also have the needle or needles mounted on a base with circular cross section and the protecting structure could be made of rigid side walls could covering at least 180° of the circular cross section of the base.

In a fifth embodiment (not depicted), the fixture might also include having the protecting structure composed of one or more solid legs extending from the base that have feet that enable for the fixture to stand in a substantially stable state when placed on a horizontal surface.

As shown in the drawings, the fill fixture is flexibly attached through flexible tubes 65 to the cartridge refill station which allows the needles to be manually inserted into the cartridge. Since the needles are not attached in a fixed position to the cabinet 12 of the refill machine 10 (or in a fixed recessed position on the cabinet) in the embodiments shown in FIGS. 1-5, the needle guard 72 of the present invention is even more important to avoid mishaps.

In a further embodiment, as shown in FIG. 6, the fill fixture 66d and protecting structure are rigidly attached to a releasable cartridge holder 90 in the housing of a cartridge refill station that can be moved up and down manually or automatically so that the needles are inserted into the cartridge.

The fixtures and protecting structure in all embodiments are fluidly connected to a cartridge refill device.

In a refill operation and referring to FIGS. 2-5, a decision is made to initiate a refill operation in the refill station 10 using the fill fixture 66 with protected needles. The cartridge is then positioned in a clamping mechanism (not depicted) designed to seal the nozzles during the refill process. Under mechanical clamping pressure, a leak-proof seal with the nozzles in the printhead is created. In a preferred embodiment, the clamping mechanism is an inexpensive molded plastic component that is configured to snap lock onto the cartridge and at least seal the printhead nozzles. With the fill fixture arranged so that the needles are pointing down, the needles 68 are then inserted into the access holes in the cartridge body, when the fill fixture is manually moved by the operator in the direction of arrow 69 to establish fluid contact with the ink chamber in the cartridge body.

The access holes in cartridge body are normally positioned opposite the printhead nozzles to ensure that the end of the needles after insertion is near the printhead nozzles. The fill fixture and cartridge body are then placed in the vacuum chamber, (negative) vacuum pressure in the cartridge is created and then ink flow is established to begin the flow of the correct volume of ink into the ink chamber in the cartridge body. Of course, prior to introducing ink into the cartridge, it is usually preferable to purge the fill lines 65 and needles 68 of any residual ink. As the vacuum pressure is applied, the ink is forced to flow in the chamber to fill the chamber. A vacuum of equal to or larger than 300 mm of Hg (as defined as the difference between atmospheric pressure and the pressure in the vacuum chamber) has been found to produce satisfactory results. The refill operation continues until the reservoir is filled to the desired level.

When filing is complete, the operator is instructed to lift chamber door 64 and remove the cartridge from the chamber 62. The operator is also instructed to remove the needles 68 from the cartridge along with the nozzle clamping mechanism, so that a print test of the cartridge can be conducted, the purpose of which is verify that the refill procedure was successful. Assuming a satisfactory print test, preferably the cartridge is then clamped with the nozzle clamping device and given back to the customer who restores the cartridge to its normal operating location on printer.

The invention is applicable to refilling any type of printhead configurations where needs are used. While the embodiments disclosed herein is preferred, it will be appreciated from this teaching that various alternative, modifications, variations or improvements therein may be made by those skilled in the art, which are intended to be encompassed by the following claims:

1. A fixture suitable for refilling an ink jet cartridge, said fixture having a base and affixed to the base, one or more needles to deliver ink to an ink jet cartridge, where the one or more needles are prevented from accidentally harming the user or breakage by a partially to totally surrounding rigid structure extending from the base at least along the entire length of the longest needle and spaced apart from the needle(s) to define a space for the ink jet cartridge.

2. The fixture of claim 1 where the partially to totally surrounding rigid structure extends beyond the length of the longest needle.

3. The fixture of claim 1 where the one or more hollow needles comprises one hollow needle.

4. The fixture of claim 1 where the one or more hollow needles comprise three hollow needles of the same or differing lengths.

5. The fixture of claim 1 where the one or more hollow needles are mounted on a base with rectangular cross section and the protecting structure is made of solid sheet metal.

6. The fixture of claim 1 where the one or more hollow needles are mounted on a base with rectangular cross section and the protecting structure is made of solid sheet metal walls and covers at least two sides of the rectangular cross section.

7. The fixture of claim 1 where the one or more hollow needles are mounted on a base with rectangular cross section and the protecting structure is made of solid sheet metal walls and surrounds three sides of the base.

8. The fixture of claim 1 where the one or more hollow needles are mounted on a base with circular cross section and the protecting structure is made of solid sheet metal walls and covers at least 180° of the circular cross section.

9. The fixture of claim 1 where the protecting structure is composed of one or more solid legs that enable for the fixture to stand in a substantially stable state when placed on a horizontal surface.

10. The fixture of claim 1 suitable for refilling an ink reservoir or reservoirs of an ink jet cartridge which contains foam or other porous material.

11. The fixture of claim 1 where the fixture and protecting structure are rigidly attached to a holder of a cartridge refill station that can be moved manually or automatically so that the one or more needles are inserted into the cartridge.

12. The fixture of claim 1 where the fixture and protecting structure are flexibly connected to a cartridge refill station and the one or more needles are manually inserted into the cartridge.

13. The fixture of claim 1 where the fixture and protecting structure are fluidly connected to a cartridge refill device.
